(19) United States
(12) Patent Application Publication
(10) Pub. No.: US 2006/0264199 A1
(43) Pub. Date: Nov. 23, 2006

(54) Hold time reporting in communication systems

(75) Inventors: Cynthia K. Florkey, Chicago, IL (US); Ruth S. Gayde, Naperville, IL (US); Victoria M. Halsell, Bolingbrook, IL (US); Karla R. Hunter, Naperville, IL (US); E-Ling Lou, Naperville, IL (US)

Correspondence Address: DUFT BORNSEN & FISHMAN, LLP, 1526 SPRUCE STREET, SUITE 302, BOULDER, CO, 80302, US

(73) Assignee: Lucent Technologies Inc.

(21) Appl. No.: 11/132,697

(22) Filed: May 19, 2005

(51) Int. Cl. H04M 11/00

(52) U.S. Cl. 455/405

(57) ABSTRACT

A communication system is disclosed that includes a communication network and a billing system. The communication network connects a call between a calling device and a destination. During the call, the destination puts the calling device on hold. The destination tracks the time the subscriber is on hold, and generates hold information for the call. The communication network receives the hold information from the destination, and transmits the hold information to the billing system. The billing system bills for the call based on the hold information and other relevant information. The billing system may bill hold time for the call differently than active time for the call.

### BACKGROUND OF THE INVENTION

1. Field of the Invention

The invention is related to the field of communication systems and, in particular, to the reporting of hold time for a call in a communication network. More particularly, a communication network reports hold information for a call to a billing system so that hold time for the call may be billed differently than active time for the call.

2. Statement of the Problem

Many service providers track minutes or seconds for a call in order to provide time-based or usage-based billing. For instance, wireless service providers commonly track air time for calls, and bill a subscriber on a monthly basis based on the total air time used during that month. If the subscriber subscribes to a service plan offering a maximum amount of air time per month, then a billing system for the service provider compares the total air time used for the month versus the maximum amount of air time allowed under the plan, and bills the subscriber for the service plan amount and any overages. Similarly, wireline service providers commonly track long distance minutes for calls. The service providers then bill the subscriber on a cost-per-minute basis.

In a wireless communication network, an originating Mobile Switching Center (MSC) receives a call from a wireless calling device (e.g., a cell phone) of a subscriber. The originating MSC then routes the call to a terminating node, such as another MSC in the wireless communication network or a switch in a wireline communication network, for connecting the call to a destination for the call. When the call is established, the originating MSC tracks the air time used for the call. When the call is torn down, the originating MSC transmits call information in the form of a call record to a billing system for the service provider. The call record indicates the air time used for the call. The billing system can then accumulate air time for the subscriber and bill the subscriber, such as on a monthly basis.

The service plan of the subscriber may also be prepaid. For prepaid service, the originating MSC transmits call information periodically or in real-time to the billing system during a call. The billing system in this instance may also be referred to as a prepaid server. The billing system then processes the call information and decrements the air time for the current call from a prepaid account in real-time. If the prepaid account is drained, then the billing system reports this to the originating MSC which may tear down the call.

One problem with current time-base or usage-based billing is that active time on a call is not distinguished from hold time on the call. Active time refers to time on a call where an active voice conversation is taking place. Hold time refers to time on a call where one of the parties has activated a hold state, a wait state, or any other state where an active voice conversation is not taking place. If a caller is placed on hold during a call, that caller is still billed based on the total time for the call regardless of how long that caller is on hold. This can be a particular problem for wireless subscribers as more and more wireless subscribers are using their cell phones as home phones and business phones.

As an example of the problem, assume a wireless subscriber places a call to a large business utilizing a call center. The call center answers the call, but all agents at the call center are currently busy on other calls. The call center will then put the subscriber on hold until an agent is available. Depending on the size of the business and the time of the call, this hold time for the agent may be five minutes, ten minutes, or more. When an agent is available, the call center connects the call to the agent, and the subscriber may converse with the agent. Subsequently, the agent may need to put the subscriber on hold again for a variety of reasons. Once again, this hold time may be several minutes. After the call has ended, the subscriber will be billed for the total air time for the call even though the amount of time on hold may exceed the time the subscriber was actually speaking to the agent.

Thus, it would be desirable for communication networks to distinguish between active time and hold time for calls.

### SUMMARY OF THE SOLUTION

The invention solves the above and other related problems by reporting hold information for a call in a communication network. The communication network of the invention receives hold information provided by the destination of the call. The communication network then reports the hold information to a billing system. By reporting the hold information to the billing system, a service provider may advantageously bill or charge hold time for a call differently than active time for the call. Thus, the service provider may distinguish its service from other service providers in a highly competitive market.

In one embodiment of the invention, a communication system of the invention includes a communication network and a billing system. The communication network receives a call from a calling device, and connects the call to a destination for the call. During the call, the destination puts the calling device (or the subscriber using the calling device) on hold at one or more instances during the call. The destination tracks the time the subscriber is put on hold for the call, and generates hold information for the call.

According to the invention, the communication network receives the hold information for the call from the destination. The communication network transmits the hold information to the billing system. The billing system receives the hold information. Subsequently, the billing system bills for the call based on the hold information and other relevant information. The billing system may bill hold time for the call differently than active time for the call. For instance, the billing system may bill the hold time at a lower rate than the active time. Alternatively, the billing system may bill for the active time, but not bill for the hold time.

The invention may include other exemplary embodiments described below.

### DESCRIPTION OF THE DRAWINGS

The same reference number represents the same element on all drawings.

FIG. 1 illustrates a communication system in an exemplary embodiment of the invention.

FIG. 2 is a flow chart illustrating a method of operating the communication system of FIG. 1 in an exemplary embodiment of the invention.

FIG. 3 illustrates another embodiment of a communication system.

FIG. 4 illustrates another embodiment of a communication system.

FIGS. 5-7 are signaling diagrams illustrating exemplary operations of the communication system in FIG. 4.

### DETAILED DESCRIPTION OF THE INVENTION

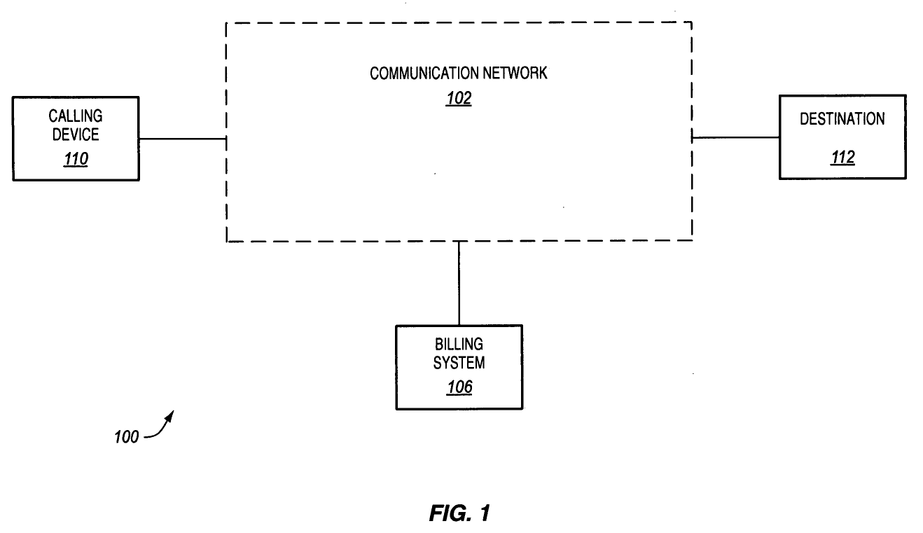

FIGS. 1-7 and the following description depict specific exemplary embodiments of the invention to teach those skilled in the art how to make and use the invention. For the purpose of teaching inventive principles, some conventional aspects of the invention have been simplified or omitted. Those skilled in the art will appreciate variations from these embodiments that fall within the scope of the invention. Those skilled in the art will appreciate that the features described below can be combined in various ways to form multiple variations of the invention. As a result, the invention is not limited to the specific embodiments described below, but only by the claims and their equivalents.

FIG. 1 illustrates a communication system 100 in an exemplary embodiment of the invention. Communication system 100 comprises a communication network 102 connected to a billing system 106. Communication network 102 may comprise a wireless network, a wireline network, a circuit-based network, a packet-based network, or any other network or combination thereof. Billing system 106 comprises any system or server that bills for call(s). Billing system 106 may comprise a regular post-paid billing system that generates bills at the end of a time period, or a prepaid billing system. Billing system 106 is illustrated as being separate from communication network 102, but may be integrated in communication network 102. Communication system 100 may include other networks, systems, or devices not shown in FIG. 1.

Communication network 102 is operable to connect a call between a calling device 110 and a destination 112. Some assumptions are made for this embodiment. One assumption is that a call has been established between calling device 110 and destination 112. Another assumption is that destination 112 puts calling device 110 on hold at one or more instances during the call. Being on hold means that a call is connected but one party is not active on the call. Another assumption is that destination 112 is properly equipped to track the time on hold for the call and to transmit hold information to communication network 102. Destination 112 may include an Automatic Call Distributor (ACD), an enhanced PBX, or another device currently known or developed in the future that is able to track the hold time for calls and transmit the hold information to communication network 102.

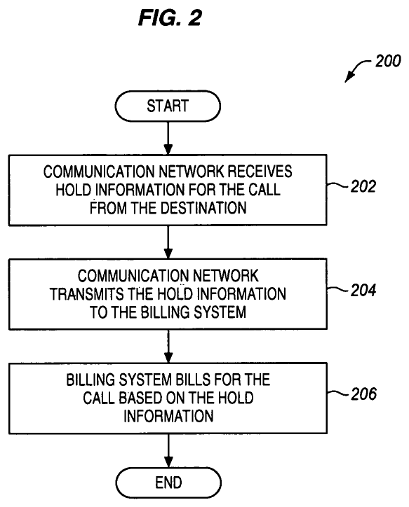

FIG. 2 is a flow chart illustrating a method 200 of operating communication system 100 in an exemplary embodiment of the invention. The steps of the flow chart in FIG. 2 are not all inclusive and may include other steps not shown.

In step 202 of method 200, communication network 102 receives hold information for the call from destination 112. Destination 112 may transmit the hold information over a signaling path between destination 112 and communication network 102. Hold information comprises any data or information that indicates if a party is on hold and/or a duration that a party is on hold during a call. The hold information may comprise an indicator of minutes, an indicator of seconds, or any other information indicating that calling device 110 was put on hold by destination 112.

In step 204, communication network 102 transmits the hold information to billing system 106. The hold information may vary depending on billing system 106. For instance, if billing system 106 is a traditional billing system, then the hold information may comprise a call record. Alternatively, if billing system 106 is a prepaid billing system, then the hold information may comprise hold messages, such as a HOLD_START message or a HOLD_STOP message.

In step 206, billing system 106 bills for the call based on the hold information and other relevant information. Billing system 106 may bill hold time for the call differently than active time for the call. Billing system 106 may bill the hold time at a lower rate than the active time. Alternatively, billing system 106 may bill for the active time, but not bill for the hold time.

Method 200 or individual steps of method 200 may be performed during the call (in real-time) or after the call has ended. Communication network 102 may receive the hold information at the end of the call or at multiple times during the call, such as every minute (see step 202). Communication network 102 may transmit the hold information to billing system 106 at the end of the call or at multiple times during the call (see step 204). If communication network 102 transmits the hold information at the end of the call, communication network 102 may accumulate hold information received during the call, and transmit the hold information to billing system 106 after the call has ended. Communication network 102 may also transmit the hold information at the end of the call when it receives the hold information from destination 112. If communication network 102 transmits the hold information during the call, communication network 102 transmits the hold information to billing system 106 in real-time responsive to receiving the hold information from destination 112.

Communication system 100 as described in FIGS. 1-2 advantageously distinguishes between active time for a call and hold time for a call. By tracking the hold time for a call and reporting the hold time to billing system 106, billing system 106 may bill the hold time differently than the active time. This is a major advantage for wireless users that use their wireless phone as their home phone or business phone.

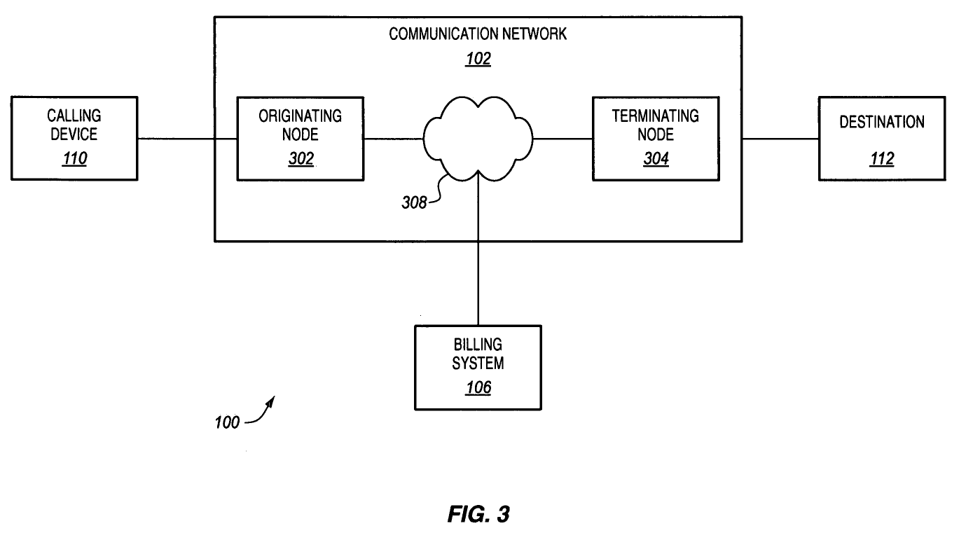

FIG. 3 illustrates another embodiment of communication system 100 in an exemplary embodiment of the invention. Communication system 100 is not limited to this embodiment, and may have other configurations in other embodiments. In this embodiment, communication network 102 includes an originating node 302, a network cloud 308, and a terminating node 304. The network cloud 308 between originating node 302 and terminating node 304 illustrates that originating node 302 may be connected to terminating node 304 through any type of network, such as a circuit-based network, a packet-based network, etc. Originating node 302 comprises any network node originating a call into communication network 102 from calling device 110. Examples of originating node 302 include an originating MSC or an originating switch. Terminating node 304 comprises any network node terminating a call to destination 112. Examples of terminating node 304 include a terminating MSC or a terminating switch.

When in operation, terminating node 304 receives hold information for the call from destination 112. Destination 112 may transmit the hold information over a signaling path between destination 112 and terminating node 304. The hold information may comprise an indicator of minutes, an indicator of seconds, or any other information indicating that calling device 110 was put on hold by destination 112. Terminating node 304 may receive the hold information from destination 112 at the end of the call. Terminating node 304 may alternatively receive the hold information from destination 112 multiple times during the call, such as every minute, for real-time reporting of the hold information. Terminating node 304 then transmits the hold information to originating node 302.

Originating node 302 receives the hold information, and transmits the hold information to billing system 106. The hold information may vary depending on billing system 106. For instance, if billing system 106 is a traditional billing system, then the hold information may comprise a call record. Alternatively, if billing system 106 is a prepaid billing system, then the hold information may comprise hold messages, such as a HOLD_START message or a HOLD_STOP message.

Originating node 302 may transmit the hold information to billing system 106 at the end of the call. For instance, originating node 302 may receive the hold information at the end of the call from terminating node 304, and generate a call record that includes the hold information. Originating node 302 may also accumulate hold information received during the call, and generate the call record after the call has ended. The call record may comprise a call detail record as traditionally generated by network nodes, or may comprise any other type of call record.

Alternatively, originating node 302 may transmit the hold information to billing system 106 multiple times during the call, such as every minute. For instance, originating node 302 may receive the hold information from terminating node 304 in real-time during the call. Originating node 302 may then transmit a HOLD_START message or a HOLD_STOP message in real-time responsive to receiving the hold information.

Originating node 302 also tracks the total call time for the call. Originating node 302 may also transmit the total call time to billing system 106.

Billing system 106 receives the hold information from originating node 302 in the form of a call record, hold messages, or some other form. Billing system 106 bills for the call based on the hold information. Billing system 106 may bill hold time for the call differently than active time for the call. For instance, if billing system 106 receives the hold information for the call from originating node 302 and a total call time for the call from originating node 302, then billing system 106 may subtract the hold time from the total call time to calculate the active time for the call. Billing system 106 may then bill the hold time at a lower rate than the active time. Alternatively, billing system 106 may bill for the active time, but not bill for the hold time.

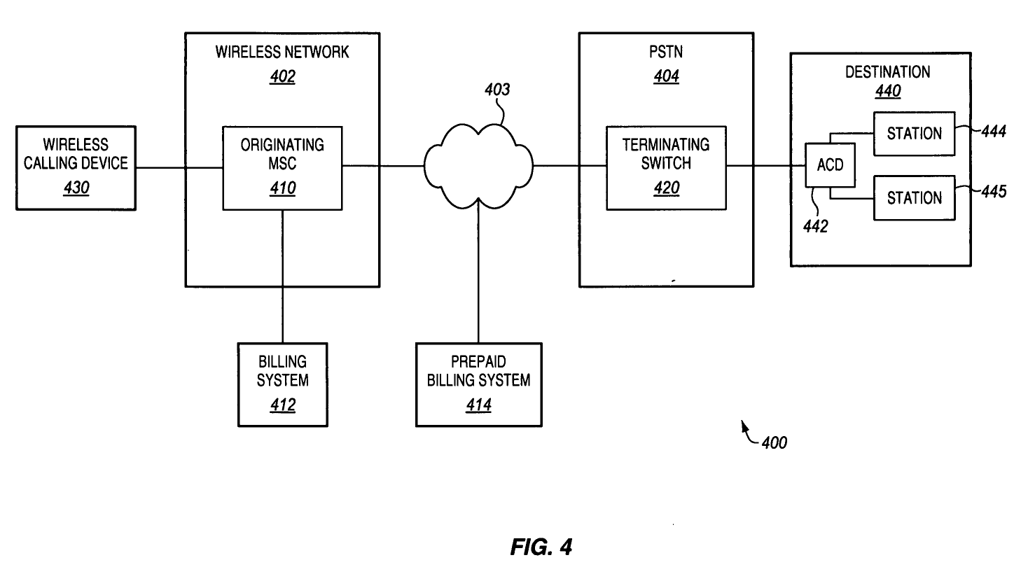

FIG. 4 illustrates another embodiment of a communication system 400. In this embodiment, communication system 400 includes a wireless network 402, a network cloud 403, a public switched telephone network (PSTN) 404, a regular post-paid billing system 412, and a prepaid billing system 414. The network cloud 403 between wireless network 402 and PSTN 404 illustrates that they may be connected through any type of network, such as a circuit-based network, a packet-based network, etc. Wireless network 402 includes an originating MSC 410 that serves a wireless calling device 430. PSTN 404 includes a terminating switch 420 that serves a destination 440. Destination 440 includes an ACD 442 connected to a plurality of stations 444-445. Each station 444-445 is manned by an agent (not shown). Communication system 400 may include other networks, systems, or devices not shown in FIG. 4.

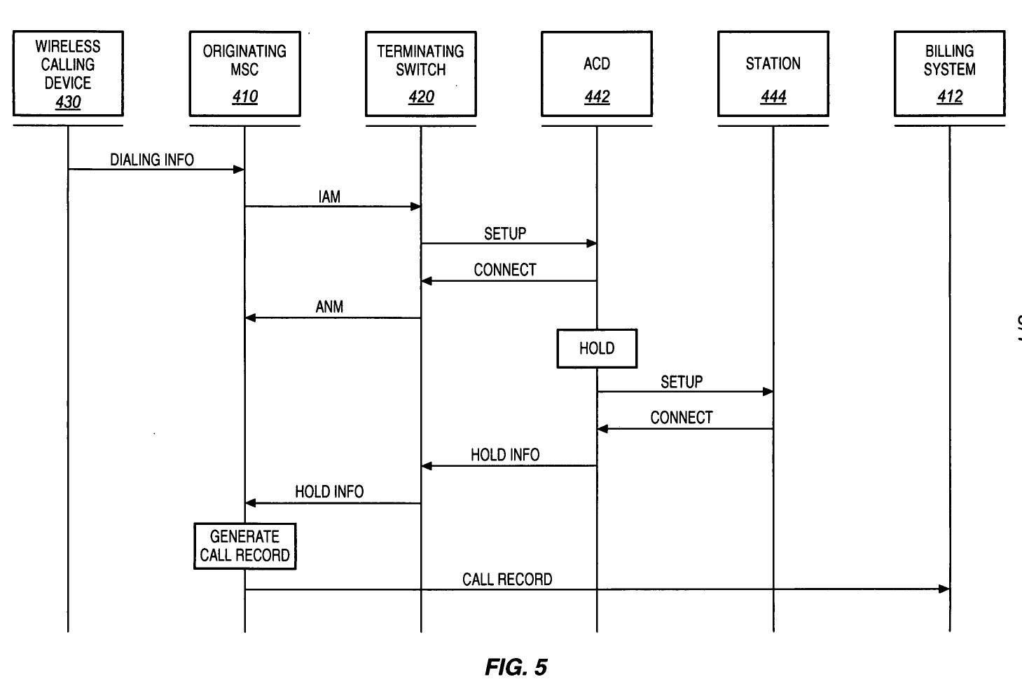

FIG. 5 is a signaling diagram illustrating the operation of communication system 400 in one embodiment. Through wireless calling device 430 (e.g., a cell phone), a subscriber to the wireless service initiates a call to destination 440. Originating MSC 410 receives dialing information for the call from wireless calling device 430. Responsive to the dialing information, originating MSC 410 transmits an Initial Address Message (IAM) to terminating switch 420. Terminating switch 420 then transmits a setup message to ACD 442 to set up the call. ACD 442 responds to terminating switch 420 with a connect message. Responsive to the connect message, terminating switch 420 transmits an Answer Message (ANM) to originating MSC 410. The call is thus established.

With the call established, ACD 442 attempts to locate an available agent to handle the call. ACD 442 determines that all agents are currently busy. Thus, ACD 442 puts the subscriber on hold and enters the call in a queue to be handled in the future. ACD 442 also starts a hold timer for the call.

When an agent becomes available to handle the call, ACD 442 transmits a setup message to the station 444 of the available agent. The receiving station 444 responds with a connect message. ACD 442 then stops the hold timer. The agent converses with the subscriber to handle the call. If the agent needs to put the subscriber on hold at some point during the call, ACD 442 detects the hold state and again starts the hold timer. When the agent subsequently takes the subscriber off hold, ACD 442 detects the state change and stops the hold timer.

During the call or after the call has ended, ACD 442 transmits hold information for the call to terminating switch 420. The hold information is based on the hold timer maintained by ACD 442 during the call. Terminating switch 420 transmits the hold information to originating MSC 410 with any desired signaling message. Originating MSC 410 receives the hold information.

If the subscriber is billed on a monthly basis, then originating MSC 410 collects the hold information for the call and calculates a total hold time for the call. Originating MSC 410 generates a call record and inserts the total hold time in the call record. Originating MSC 410 also tracks the total call time for the call and inserts the total call time in the call record. Originating MSC 410 then transmits the call record to billing system 412.

Based on the call record, billing system 412 subtracts the hold time for the call from the total call time to calculate the active time for the call. Billing system 412 then generates a bill for the subscriber where the hold time for the call is billed differently than the active time for the call. For instance, billing system 412 may bill the hold time at a lower rate than the active time. Alternatively, billing system 412 may bill for the active time, but not bill for the hold time.

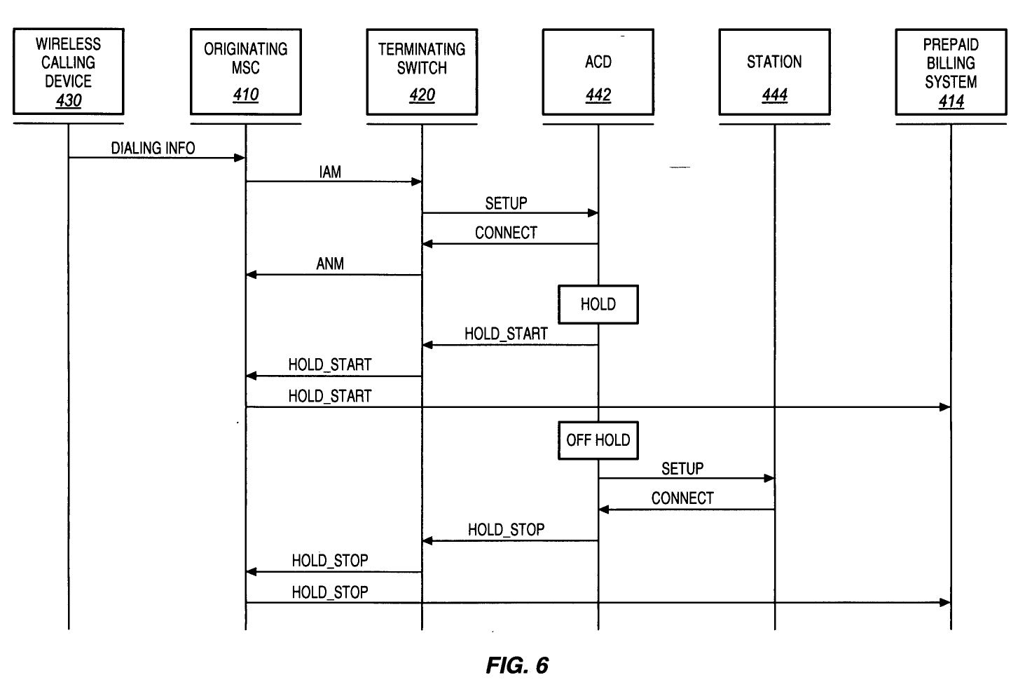

FIG. 6 is a signaling diagram illustrating the operation of communication system 400 when prepaid billing system 414 is used in another embodiment. Communication system 300 operates substantially as described above for FIG. 5. When ACD 442 puts wireless calling device 430 on hold, ACD 442 transmits a HOLD_START message to terminating switch 420 during the call. The HOLD_START message indicates when the calling device 430 is on hold. Terminating switch 420 transmits the HOLD_START message to originating MSC 410. Originating MSC 410 transmits the HOLD_START message to prepaid billing system 414.

Prepaid billing system 414 receives the HOLD_START message indicating that the calling device 430 is on hold. Prepaid billing system 414 can then determine how much time to decrement from the prepaid account based on the HOLD_START message. Prepaid billing system 414 may handle the hold time differently than active time. For instance, prepaid billing system 414 may not decrement hold time from the prepaid account based on the hold messages. Alternatively, prepaid billing system 414 may decrement hold time at a different amount than active time, such as decrementing one minute from the prepaid account for every five minutes of hold time.

When ACD 442 takes wireless calling device 430 off hold, ACD 442 transmits a HOLD_STOP message to terminating switch 420 during the call. The HOLD_STOP message indicates when the calling device 430 is taken off hold. Terminating switch 420 transmits the HOLD_STOP message to originating MSC 410. Originating MSC 410 transmits the HOLD_STOP message to prepaid billing system 414.

Prepaid billing system 414 receives the HOLD_STOP message indicating that the calling device 430 is off hold. Prepaid billing system 414 can then resume billing calling device 430 in a normal manner. Many such hold messages may be transmitted to prepaid billing system 414 during the call depending on how many times calling device 430 is put on hold during the call.

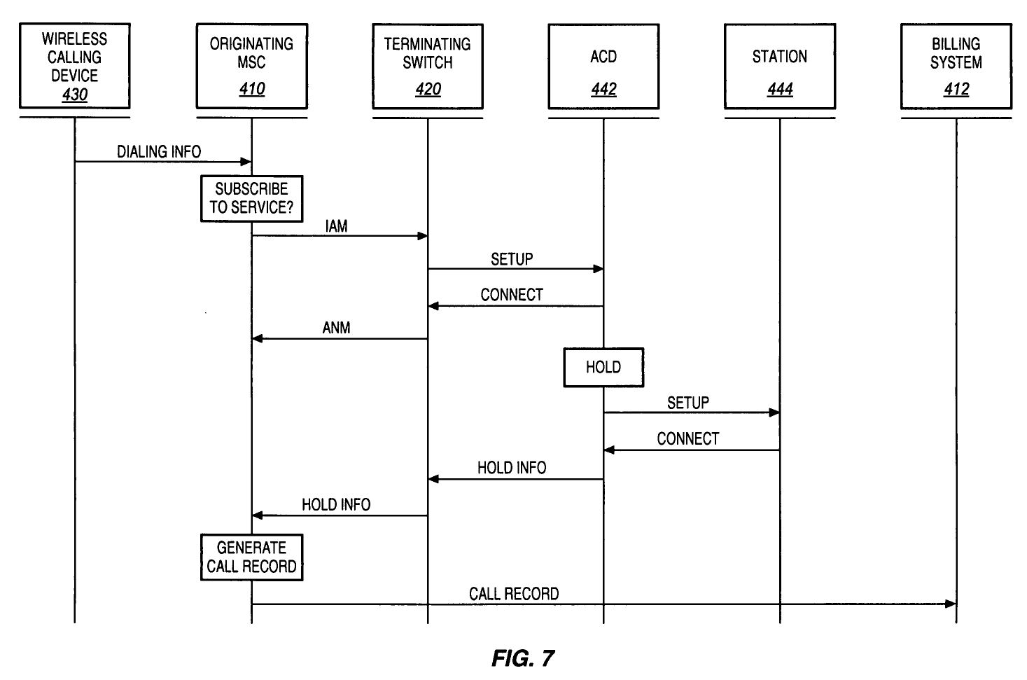

FIG. 7 is another signaling diagram illustrating the operation of communication system 400 in another embodiment. Through wireless calling device 430, a subscriber to the wireless service initiates a call to destination 440. Originating MSC 410 receives dialing information for the call from wireless call device 430. Originating MSC 410 checks a subscriber record for the subscriber to determine if the subscriber has subscribed to a service that charges hold time differently than active time. The subscriber record may be stored in a Home Location Register (HLR) for the subscriber. In this instance, assume that the subscriber has subscribed to such a service.

Originating MSC 410 then transmits an IAM to terminating switch 420. The IAM includes a request for hold information from terminating switch 420. Responsive to the IAM, terminating switch 420 transmits a setup message to ACD 442 to set up the call. ACD 442 responds to terminating switch 420 with a connect message. Responsive to the connect message, terminating switch 420 transmits an ANM to originating MSC 410. The call is thus established.

With the call established, ACD 442 attempts to locate an available agent to handle the call. ACD 442 determines that all agents are busy. Thus, ACD 442 puts the subscriber on hold and enters the call in a queue to be handled in the future. ACD 442 also starts a hold timer for the call.

When an agent becomes available to handle the call, ACD 442 transmits a setup message to the station 444 for the available agent. The station 444 responds with a connect message. ACD 442 then stops the hold timer. The agent converses with the subscriber to handle the call. If the agent needs to put the subscriber on hold at some point during the call, ACD 442 detects the hold state and again starts the hold timer. When the agent subsequently takes the subscriber off hold, ACD 442 detects the state change and stops the hold timer.

At some point during the call or after the call has ended, ACD 442 transmits hold information for the call to terminating switch 420. The hold information is based on the hold timer maintained by ACD 442 during the call. Terminating switch 420 transmits the hold information to originating MSC 410 with any desired signaling message. Originating MSC 410 and billing system 412 may then operate as described above to bill for the call.

The service provider and the destination 440 may have some type of agreement to provide this service to the subscriber. In consideration for destination 440 transmitting the hold information to communication system 400, the service provider may advertise on behalf of destination 440 by offering free hold time minutes for calls to destination 440. For instance, assume that destination 440 comprises a large pizza delivery business. The service provider may advertise that free hold minutes are provided for calls to the pizza delivery business. By doing so, the service provider may acquire more subscribers while providing the pizza delivery business with more pizza business.

We claim:

1. A communication system, comprising:
a billing system; and
a communication network operable to connect a call between a calling device and a destination, to receive hold information for the call from the destination, and to transmit the hold information to the billing system;
wherein the billing system is operable to receive the hold information, and to bill for the call based on the hold information.

2. The communication system of claim 1 wherein the billing system bills hold time for the call differently than active time for the call.

3. The communication system of claim 2 wherein the hold time is billed at a reduced rate compared to the active time.

4. The communication system of claim 2 wherein the hold time is not billed.

5. The communication system of claim 1 wherein the communication network is further operable to:
generate a call record that includes the hold information; and
transmit the call record to the billing system.

6. The communication system of claim 1 wherein the communication network is further operable to:
transmit hold messages that include the hold information to the billing system.

7. The communication system of claim 1 wherein the communication network transmits the hold information to the billing system at the end of the call.

8. The communication system of claim 1 wherein the communication network transmits the hold information to the billing system during the call.

9. A method of operating a communication system, the method comprising:
connecting a call between a calling party and a destination over a communication network;
receiving hold information for the call in the communication network from the destination;
transmitting the hold information from the communication network to a billing system; and
billing for the call in the billing system based on the hold information.

10. The method of claim 9 wherein billing for the call in the billing system based on the hold information comprises:
billing hold time for the call differently than active time for the call.

11. The method of claim 10 wherein the hold time is billed at a reduced rate compared to the active time.

12. The method of claim 10 wherein the hold time is not billed.

13. The method of claim 9 wherein transmitting the hold information from the communication network to a billing system comprises:
generating a call record that includes the hold information in the communication network; and
transmitting the call record from the communication network to the billing system.

14. The method of claim 9 wherein transmitting the hold information from the communication network to a billing system comprises:
transmitting hold messages that include the hold information from the communication network to the billing system.

15. The method of claim 9 wherein transmitting the hold information from the communication network to a billing system comprises:
transmitting the hold information from the communication network to the billing system at the end of the call.

16. The method of claim 10 wherein transmitting the hold information from the communication network to a billing system comprises:
transmitting the hold information from the communication network to the billing system during the call.

17. A communication system, comprising:
a billing system;
an originating node that serves a calling device for a call; and
a terminating node that serves a destination for the call;
wherein the terminating node is operable to receive hold information for the call from the destination, and to transmit the hold information to the originating node;
wherein the originating node is operable to receive the hold information, and to transmit the hold information to the billing system;
wherein the billing system is operable to receive the hold information, and to bill for the call based on the hold information.

18. The communication system of claim 17 wherein the billing system bills hold time for the call differently than active time for the call.

19. The communication system of claim 18 wherein the hold time is billed at a reduced rate compared to the active time.

20. The communication system of claim 18 wherein the hold time is not billed.
